(19) United States
(12) Patent Application Publication
(10) Pub. No.: US 2024/0093999 A1
(43) Pub. Date: Mar. 21, 2024

(54) SYSTEMS, METHODS, AND PROGRAM PRODUCTS FOR GUIDING A USER IN AN OUTDOOR ACTIVITY

(71) Applicant: Trail Chat, LLC, Putnam Valley, NY (US)

(72) Inventor: Shari Inga Goodstein, Putnam Valley, NY (US)

(21) Appl. No.: 17/946,751

(22) Filed: Sep. 16, 2022

(51) Int. Cl. G01C 21/00

(52) U.S. Cl. CPC G01C 21/005

(57) ABSTRACT

The present invention generally relates to systems, methods and program products for guiding a participant in an outdoor activity.

### BACKGROUND

Outdoor activities that allow participants to spend time outdoors and in rural settings have become increasingly popular. Such activities include hiking, camping, horseback riding, running, mounting biking, snow mobile riding and hunting, to name a few. While these activities allow participants to better enjoy the outdoors, the fact that they are performed in remote areas, and often over large expanses of remote areas, poses certain technical problems when it comes to setting up courses, tracking the progress and safety of participants and providing guidance to the participants during the activity. Conventionally, in such activities, physical markers may be provided in the area to guide the participants. The use of physical markers, however, is very labor intensive given that these activities take place over large areas in remote places and thus require organizers to travel over the same large areas to set markers. Further, the use of physical markers in remote areas is often unreliable as these markers may easily be moved and/or obscured over time, for example by wind, water, wildlife, etc. The use of maps is also impractical in many of these activities as they require the user to stop and view the map in order to navigate safely, which is simply not a practical approach in many of these activities which require the user to focus on the activity.

Accordingly, it would be beneficial to provide a method, system and program product to provide guidance to users during outdoor activities that avoids these and other problems.

### SUMMARY

Systems, methods, and program products for guiding a participant in an outdoor activity are discussed herein.

### BRIEF DESCRIPTION OF THE DRAWINGS

Exemplary embodiments of the present invention will be described with references to the accompanying figures, wherein:

FIG. 1 illustrates an exemplary graphical representation of a map including an indication of a path or trail of a participant in an outdoor activity in accordance with exemplary embodiments of the present invention;

FIG. 2 is an exemplary flow chart illustrating steps for tracking and illustrating a path or trail of a participant while participating in the outdoor activity in accordance with exemplary embodiments of the present invention;

FIG. 2A illustrates an exemplary flow chart showing additional steps that may be used to generate and store trail information for future use based on the path of the participant while participating in the outdoor activity in accordance with exemplary embodiments of the present invention;

FIG. 2B illustrate an exemplary flow chart illustrating additional steps to retrieve user profile information associated with a user in accordance with an embodiment of the present disclosure;

FIG. 3 illustrates an exemplary flow chart illustrating steps for retrieving and displaying a previously stored trail on a graphical illustration of a map in accordance with exemplary embodiments of the present invention;

FIG. 4 illustrates an example of trail information that is shared in a community in accordance with exemplary embodiments of the present invention;

FIG. 5 illustrates an exemplary illustration of profile information that may be presented to a user in accordance with exemplary embodiments of the present invention;

FIG. 6 illustrates an exemplary trail that may be selected by a user from their profile information in accordance with an embodiment of the present disclosure;

FIG. 6A illustrates an exemplary screen shot highlighting the features of allowing a user to retrace their steps on a path and to allow the user to have third parties track their progress; and

FIG. 7 illustrates an exemplary block diagram of a computing device associated with a user that may implement the steps of the exemplary flow charts discussed above in accordance with an embodiment of the present disclosure.

### DETAILED DESCRIPTION

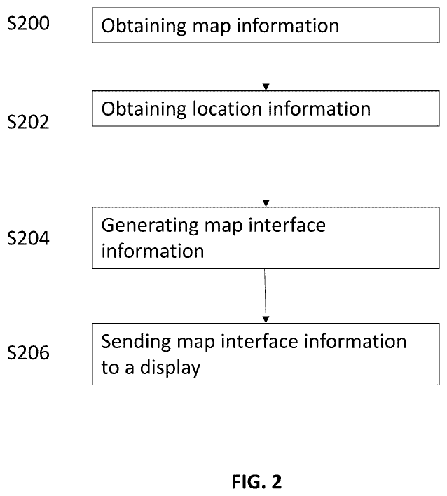

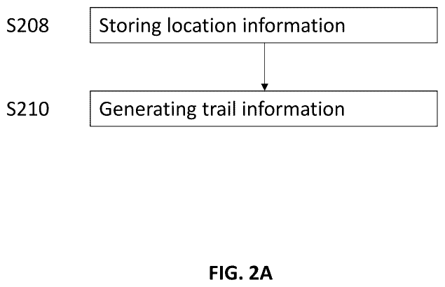

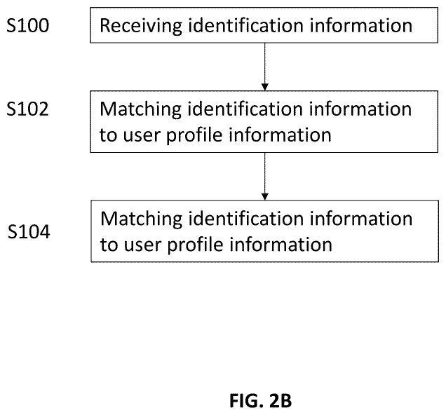

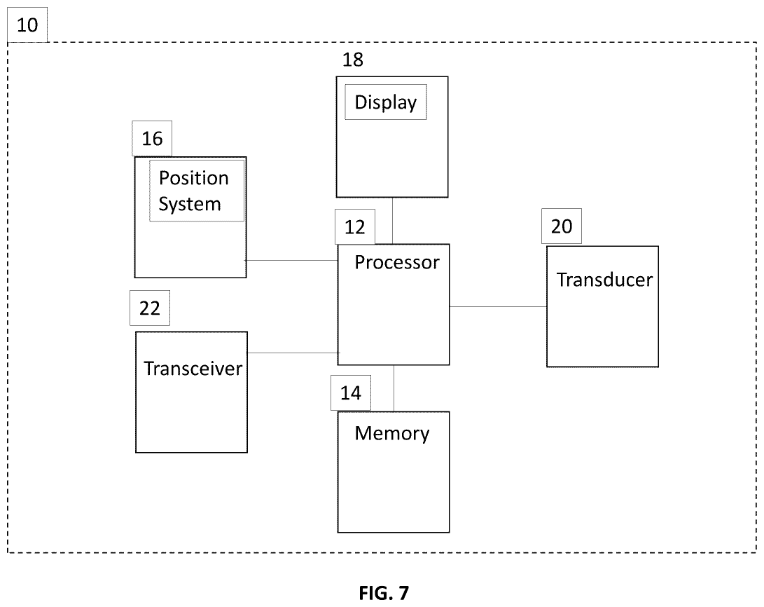

A method for providing guidance to a user during an outdoor activity is illustrated in the exemplary flow chart of FIG. 2. In embodiments, at step S200 map information associated with a first area is obtained. In embodiments, the map information may be associated with physical features of the land in the first area, including trails, roads, hills, rivers, streams, lakes and ponds, to name a few. In embodiments, the physical features may also include infrastructure such as bridges, tunnels and commercial facilities. In embodiments, the map information may be stored in a memory on a mobile electronic device (see memory 14 in FIG. 7, for example). In embodiments, the map information may be received from a remote computer or server via one or more networks, for example, the Internet, a cellular network, satellite network, or WiFi network, to name a few.

In embodiments, at step S202, location information associated with a location of the user may be obtained. In embodiments, the location information may be provided from a position system, such as a GPS device or system (see FIG. 7, for example). In embodiments, the location information may be received from a positioning system provided on a portable electronic device 10 (see FIG. 7) associated with the user, such as a smart phone, tablet or laptop computer, to name a few. In embodiments, the location information may be provided by another device associated with the user, for example, a smart watch, laptop, etc.

In embodiments, map interface information may be generated in step S204 based on the map information and the location information. In embodiments, the map interface information may be provided to a display device or element 18 (see FIG. 7, for example) at step S206. In embodiments, the map interface information may be used to provide a visual representation of the first area and may include a location indicator associated with the location of the user in the first area on the display.

In embodiments, steps S202-206 may be repeated as the user moves in the first area such that location of the user is continually updated on the visual representation of the map as the user moves through the first space to provide a real time indication of the location of the user as well as an indication of the path they have taken to get there. In embodiments, steps S202-206 may be repeated for a predetermined period of time. In embodiments, steps 202-206 may be repeated until the user reaches a desired location in the first space or until the user returns to an origin point. In embodiments, steps 202-206 may repeated until the user indicates that that repeating should stop, that is, that they have completed their participation in the activity. In embodiments, the location information may be used to provide indicia on the map to show where the user was throughout participation in the activity such that the user can retrace their steps if necessary. In embodiments, the location information may be used to determine speed of the user during the activity, the distance traveled as well as the amount of time they have been participating in the activity. In embodiments, the calories burned during the user's activity may also be determined. In embodiments, this information may be displayed to the user on the display.

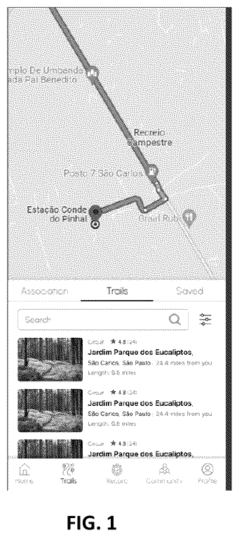

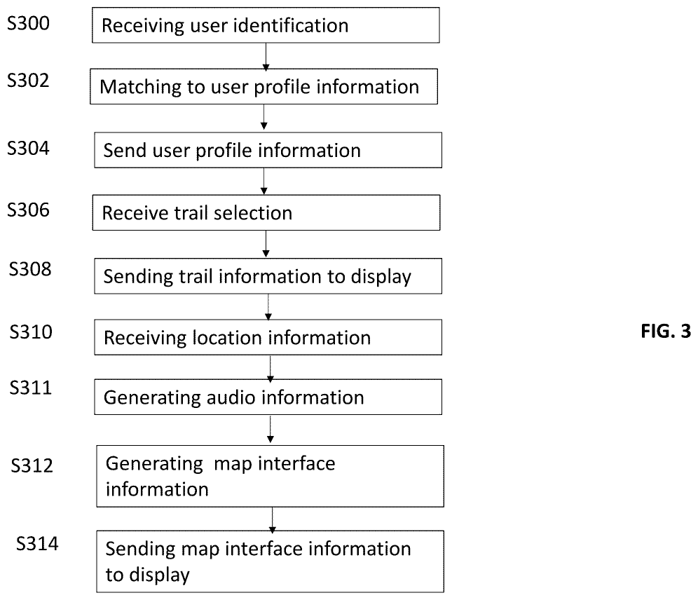

In embodiments, the location information, including the speed, distance, time and calorie information, may be stored in one or more memory elements to create a record of the movement of the user at step S208 as can be seen in FIG. 2A. In embodiments, a user may decide to create a trail or path that may be accessed in the future, by either the user, or others, based on their path. In embodiments, trail information may be generated based on the stored location information in step S210. In embodiments, the trail information may indicate the path or trail that the user took which may be used by the user, or other users to follow in the future. In embodiments, such trail information may be provided to the display and be displayed to the user as discussed below with reference to FIG. 3. FIG. 1 illustrates an example of such a trail indicated in the graphic representation of the map. In embodiments, the trail information may also include a total length of the trail.

In embodiments, user profile information may be received from users or otherwise received or obtained and stored in a memory. In embodiments, the user profile information may include or be associated with prior trails established or taken by the user as well as trails of others that are preferred by the user. In embodiments, the profile information may include other suggested trails that may be selected for inclusion based on prior trails of the user. In embodiments, trails may also be suggested based on the user's current location, by zipcode, by address or by trail length. In embodiments, the profile information may include preference information associated with preferred trail length and/or locations. In embodiments, preferences of the user may be determined based on prior trails used by the user. In embodiments, the trail information discussed above may be associated with or included in the profile information. In embodiments, the user profile information may be stored in one or more memory devices, either in or associated with a mobile electronic device (see FIG. 7, for example) associated with the user or at a remote computer device such as a server or other computer system that may be communicated with via the one or more communication networks. In embodiments, the user profile information may include or be associated with user identification information unique to each user.

In embodiments, prior to step S200, respective user identification information may be received from the user in a step S100 (see FIG. 2B, for example). In embodiments, the respective user identification information may be matched to corresponding user profile information in step S102. In embodiments, the corresponding user profile information may be provided to the display device in step S104. The user profile information will be displayed to the user on the display device. In embodiments, the user profile information shown to the user may include information regarding prior trails associated with the user or trails of others preferred by the user and/or suggested trails. In embodiments, it may not be necessary for a user to provide identification information in order to use certain features, in which case, steps S100 to S104 may not be needed. In such cases, the user may have limited access and may only be able to use the steps of FIG. 2, for example.

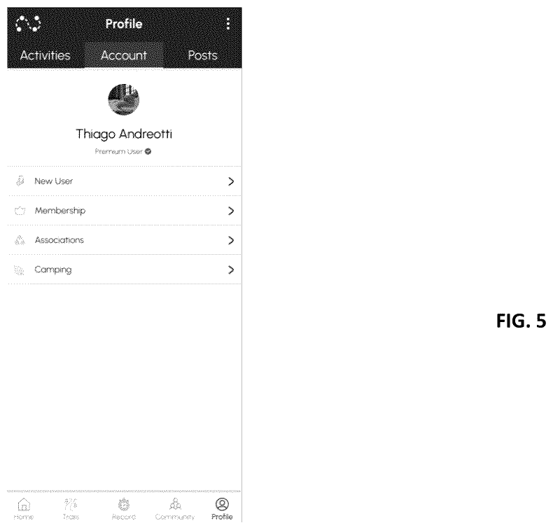

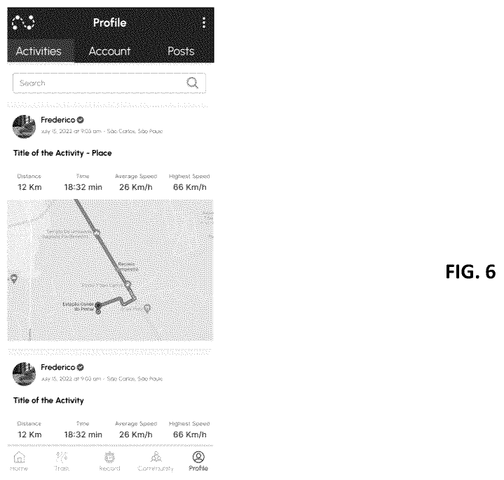

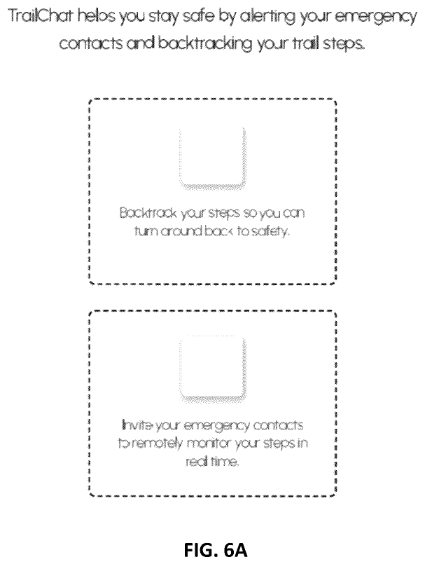

In embodiments, a user may pay a fee for access to the method of the present application. In embodiments, the user profile information may include account information which may include payment information associated with payments made by each respective user. An example of the profile information is also illustrated in FIG. 5, for example. In FIG. 5, exemplary account information is shown which may provide an option to add a “New User” as well as an option to view membership information associated with the current user. In embodiments, the “Activities” option may provide the opportunity to view activities that the user is either interested in or has registered to participate in. In embodiments, these activities may be associated with trails. For example, FIG. 6 illustrates an exemplary trail associated with a particular activity.

In embodiments, the trail information generated in step S210 may instead be generated based on trail parameters entered by a user. In embodiments, the user may designate markers in the first area using the trail parameters. In embodiments, the trail parameters may be entered on the graphic representation of the map directly. In embodiments, the display may be a touch screen display which may allow the user to directly enter trail parameters by touching the screen. In embodiments, the user may interact with the graphical representation of the map on the display and designate markers on the map to indicate the desired trail. In embodiments, markers may be designated on the map using other input devices. In embodiments, the trail information may be generated to connect the markers in the order designated by the user. In embodiments, the user may enter the display parameters via one or more other input elements, such as a button, switch, keyboard, mouse, voice command or other input element, for example, associated with the mobile communication device or a remote computer system.

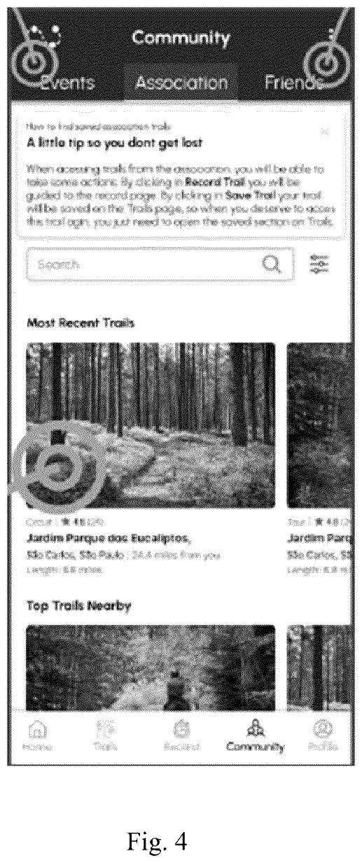

In embodiments, a user may retrieve and view a trail information associated with a trail that the user has previously traveled. In embodiments, the user may retrieve and view trail information that was previously traveled by others. In embodiments, the user may retrieved and view trail information provided by others. FIG. 3 illustrates an exemplary set of steps to retrieve and review trail information. In embodiments, at a step S300 (see FIG. 3) unique user identification information may be received from a user in a manner similar to that described above with respect to step S100 in FIG. 2B. In embodiments, at step S302, the unique user information may be matched to respective user profile information in a manner similar to that discussed above with respect to FIG. 2B. In embodiments, at step S304, the respective user profile information may be provided to a display and be presented to the user in a manner similar to that discussed above. As noted above, the user profile information may include trail information associated with the user which may be displayed to the user. In embodiments, the user profile information may include trail information of others that is preferred by the user or that is suggested to the user. In embodiments, users may join or be associated with communities and information regarding these memberships may be included in the profile information. In embodiments, these communities may share trail information between members. In embodiments, this information may include trails created by or favored by community members as indicated generally in FIG. 4, for example.

In embodiments, a selection of a trail may be received at step S306 from the user. In embodiments, the trail information associated with the selected trail may be sent to the display at step S308 and displayed with the graphical representation of the map. In embodiments, the trail information may be included in the map interface information and displayed on the display. In embodiments, the user may then follow the trail as illustrated on the graphical representation. In embodiments, in step S310, the location information associated with the user may be received in the manner described above with respect to step S202 as the user follows the trail.

In embodiments, at step S311, audio information may be generated to provide audio guidance associated with the trail. In embodiments, the audio information may be generated to provide verbal instruction to the user to follow the selected trail such that the user can receive guidance without looking at the display. In embodiments, the audio guidance may be provided based on the trail information as well as the location information of the user such that the user remains on the trail as they move in the first space. The audio information may be provided to a speaker or other transducer to provide audible instructions.

In embodiments, at step S312, map interface information may be generated as generally noted with respect to step S204 above. As noted above, indicia may be provided on the graphical representation of the map indicating the location of the user. In embodiments, at step S314, the map interface information may be provided to the display to provide an indication of the location of the user on the trail in much the same manner as described above with reference to FIG. 206. In embodiments, steps S310 to 314 may be repeated such that the location of the user is continually provided with audio guidance and the location of the user is continually updated while the user is participating in the activity and traveling on the trail.

In embodiments, the user may communicate with other users or with third parties. In embodiments, after step S306, a message indicating the selected trail may be sent to one or more other users and/or to a one or more designated third parties such that others are notified of the trail being taken by the user. This information may be useful in the event that the user is lost or injured while participating in the activity. In embodiments, the location information or a portion thereof may be sent to others or to designated third parties to provide a record of where the user was at a particular time, which may also be useful in the event the user becomes lost or injured. In embodiments, the third parties may be designated emergency contacts that are designated by the user, for example, in the user profile information. In embodiments, other messages may be sent to other users and/or third parties, for example, to make plans to meet on a certain trail or to register for a certain event, etc. In embodiments, the message may include location information to allow one user to see the location of the other on the map. In embodiments, the location information may be transmitted periodically, for example every 5 minutes, 15 minutes, etc. to provide for updates of the users status. In embodiments, the location information may be transmitted continuously in real time such that others, including designated contacts, can track the path of the user. In embodiments, while others are tracking progress of the user, they may observe periods of inactivity or unusual activity that may suggest an injury or illness of the user. In embodiments, an alert message may be generated and sent in the event that the user remains still for a period of time, which may indicate illness or injury. In embodiments, prior to sending the alert to others, the user may have an opportunity to respond and confirm that they are not injure or in need of assistance.

FIG. 7 illustrates an exemplary block diagram of a mobile electronic device 10 that may be used to implement the steps set forth in FIGS. 2, 2A, 2B and 3. In embodiments, the mobile electronic device 10 may include a processor 12 that may be operatively connected to at least one memory 14. In embodiments, the processor 12 may be a microprocessor, CPU or any other suitable programmable control device or circuit. In embodiments, the memory 14 may include processor executable code that when executed by the processor 12 performs the steps discussed above with respect to FIGS. 2, 2A, 2B and 3. In embodiments, the memory 14 may be integrated into the device 10 or may be in communication therewith. In embodiments, the memory 14 may be or may include a memory of a remote computer system that is in communication with the processor 12. In embodiments, communication may take place over any desired communication network, including but not limited to the Internet, a cellular communication system, satellite communication system, WiFi or BLUETOOTH, to name a few. In embodiments, the device 10 may include one or more transceivers (transceiver/receiver) devices 22 that may be used to communicate information via the one or more communication networks.

In embodiments, the processor 12 may be operatively connected to a positioning system 16, such as a GPS system, for example, that provides the location information associated with the location of the user. In embodiments, any suitable positioning system may be used. In embodiments, the device 10 may include a display 18 operatively connected to the processor 12 and configured to display images. In embodiments, the display 18 may be integrated into the device 10, however, the display may be integrated into another device associated with the user. In embodiments, the profile information, trail information and graphical representation of the map may be displayed on the display 18. In embodiments, as noted above, the display 18 may be a touch screen display and the user may input information, including the trail parameters via the touchscreen. In embodiments, the device 10 may include one or more other input elements, including buttons, switches, a mouse, trackball, a keyboard, or a microphone to enter voice information, to name a few. In embodiments, the processor 12 may be operatively connected to a transducer 20 such that the audio information may be provided to the user as audible speech. In embodiments, the device 10 may include a microphone, as noted above, that may be operatively connected to the processor 12 and the memory 14 may include processor executable code that when executed may be used to convert speech of the user into information that may be provided to the processor or the memory, including but not limited to trail parameters.

In embodiments, the trail information may include or be associated with trail images which may be associated with features of the trail. In embodiments, the trail images may be provided by the user or by other users, or by third parties. In embodiments, the third parties may be sponsors of events or others who maintain and market trails. In embodiments, the trail images may be provided in communities. In embodiments, information related to other services of interest may be received by the processor 12 and stored in memory 14 for display to the user, for example, horse care services or boarding, apparel, mechanical services for snow mobiles or ATVs, etc. In embodiments, this information may be retrieved via the processor 12 and provided to the display 18. In embodiments, this information may be retrieved based on the profile information associated with the user.

In embodiments, the processor executable code may be stored on the remote computer system and accessed by the processor 12. In embodiments, the user profile information, location information and trail information may be stored in a remote computer system and accessed and retrieved by the processor 12.

In embodiments, user profile information may be provided for organizations or entities other than individuals. In embodiments, any user or entity that has provided profile information may view and retrieve trail information provided by others and may provide trail information to be viewed and heard by others. In embodiments, organizations or entities may provide information regarding services or events that may be of interest to users. In embodiments, this information may be stored in the memory 14, for example, and may be presented to users via the display 18. In embodiments, the information may be displayed to the user based on a user request or search for facilities or services. In embodiments, the information may be presented to a user based on their location or activity. For example, in embodiments, a user that is following a horse trail may be presented with information related to horse friendly campsites that are in the area of the trail. In embodiments, event organizers may provide event information that may be presented to users. In embodiments, the event information may be incorporated into a calendar that may be requested by a user or shown to the user, for example, based on the user's location or activity.

The method and system disclose herein is suitable for use in a wide variety of outdoor activities and allows for efficient set-up of trails, either by tracking user progress or based on user input. In addition, the method and system of the present application allow users to easily access trail information of interest, either based on their own prior activity or based on their interest in the activity of others. Further, the method and system of the present disclosure provide for continuous tracking of user location as well as non-visual guidance which frees the user up to focus on the activity rather than a map or physical markers. FIG. 6A illustrates an exemplary screen shot of the display 18 highlighting the option for a user to retrace their steps on a path and to allow others to track their progress.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed:

1. A method as shown and described herein.
